(19) United States
(12) Patent Application Publication
(10) Pub. No.: US 2024/0144327 A1
(43) Pub. Date: May 2, 2024

(54) DIGITAL FUNDRAISING PLATFORM

(71) Applicant: GIVECLOUD INC., Ottawa (CA)

(72) Inventor: Joshua BLOOMFIELD, Richmond (CA)

(21) Appl. No.: 18/495,248

(22) Filed: Oct. 26, 2023

Related U.S. Application Data
(60) Provisional application No. 63/419,947, filed on Oct. 27, 2022.

(51) Int. Cl. G06Q 30/0279; G06Q 20/10

(52) U.S. Cl. CPC G06Q 30/0279; G06Q 20/10

(57) ABSTRACT

A method and apparatus for raising funds includes receiving from an organization, a bundle including an impact. Donations are received from donors, where each donation includes a quantity of the bundle. The donations are stored in a queue. A notification is received, from an organization, that a portion of the donations in the queue have been fulfilled. A portion of the donors whose donations are deemed to have been fulfilled is determined. A notification is sent, to the portion of donations of the donors, of an impact of their donation. The donations are then marked as fulfilled.

### CROSS-REFERENCE TO RELATED APPLICATIONS

This application claims the benefit and priority of U.S. Provisional Application 63/419,947, filed Oct. 27, 2022. The foregoing application is incorporated by reference herein in its entirety.

### FIELD OF THE INVENTION

The present invention pertains to the field of charitable donations and in particular, to a computer implemented method and system for impact based charitable donations.

### BACKGROUND

Nonprofit organizations and charities are typically tax-exempt organizations whose missions are focused on public interest and improving conditions for animals, humans, or the world that we share. The nonprofit space is large and diverse.

Many nonprofit organizations are at least partially funded through donations and spend a considerable amount of time and effort canvassing for donations at events, through direct marketing, social media, and through web sites.

There is increasing pressure on nonprofits to maximize the amount spent directly on the mission and to minimize overhead and operational costs. This is putting extreme pressure on organizations to do more with less and can result in an impact to the quality of the services they can deliver. Married with this is that there is also increasing pressure from donors to have full visibility on how and where their dollars are being spent. Nonprofits must deliver feedback and updates to their donors with respect to the impact of their organizations spending.

There are currently a multitude of vendors offering digital fundraising solutions for nonprofits and this number is growing daily as new entrants see the size and scope of the space. While there are many new organizations entering the space, there is an overwhelming lack of innovation when it comes to how fundraising is being executed. Each organization to date is simply offering subtle improvements to the standard donation form.

Therefore, there is a need for an improved digital fundraising platform that allows for donors to be more engaged with the nonprofit they are donating and that provides greater transparency to stakeholders, that overcomes the shortcomings of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a digital fundraising platform that is based on the impact of a donation rather than a monetary amount of a donation. Embodiments provide donors with an impact driven approach to donating and clarity surrounding how funds will be divided between mission delivery and other operational needs. Embodiments provide non-profits with a way to update their donors on the impact delivered through a donor's donation during program execution and provide a mechanism to communicate proof of impact of dollars spent on both mission and operational activities.

In accordance with an embodiment of the present invention, there is provided a method for raising funds including receiving, from an organization, a bundle including an impact. The method further includes receiving, from a plurality of donors, a plurality of donations where each of the plurality of donations includes a quantity of the bundle. The plurality of donations are stored in a queue, which may be or correspond to one or more data structures of a computer system. The method further includes receiving, from the organization, a notification that a portion of the plurality of donations in the queue have been fulfilled and determining a portion of the donors whose donations are deemed to have been fulfilled. The method further includes sending to the portion of donations of the donors, a notification of an impact of their donation and marking the donations as fulfilled. The method is generally performed by a computer system. The donations that are deemed to have been fulfilled may further be removed from the queue, for example concurrently with or following sending the notification of the impact.

In further embodiments, the bundle further includes a price and a breakdown of the price indicating a fulfillment portion of the price.

In further embodiments, the notification of an impact of their donation includes a fulfillment portion of the impact of their donation and animations to generate an emotional response from the donor.

In further embodiments, the notification of an impact of their donation includes a link enabling the impact of their donation to be shared with a social media site.

In further embodiments, the notification of an impact of their donation is spaced out in time to increase an emotional impact to the donor.

Embodiments further include sending to the organization a notification of performance including an impact of the plurality of donations of the bundle where the notification of performance includes a link enabling the impact of the plurality of donations of the bundle to be shared with a social media site.

In further embodiments, the plurality of donors are presented with the notification of performance is made available to the plurality of donors.

In accordance with an embodiment of the present invention, there is provided a method for making donations including receiving, from a fundraising platform, a plurality of bundles where each of the plurality of bundles is associated with an organization and including an impact. The method further includes sending, to the fundraising platform, a donation including a selected bundle of the plurality of bundles and a quantity of the selected bundle. The method also includes receiving, from the fundraising platform, a notification that a portion of the donation has been fulfilled where the notification includes an indication of an impact of the portion of the donation and an animation to increase an emotional impact of the donation.

In further embodiments, each of the plurality of bundles further includes an indicator of the effectiveness of the organization including a fulfillment portion of the impact of the bundle.

In further embodiments, the notification that the portion of the donation has been fulfilled further includes a link enabling the impact of their donation to be shared with a social media site.

In accordance with an embodiment of the present invention, there is provided a method for raising funds including sending, to a fundraising platform, a bundle including an impact where the impact defines a fulfillment portion. The method further includes receiving, from the fundraising platform, a plurality of donations of a plurality of donors where each of the plurality of donations includes a quantity of the bundle. The method also includes receiving, from the fundraising platform, a payment for the plurality of donations including a portion indicating the fulfillment portion and sending, to the fundraising platform, a report indicating that a portion of the plurality of donations have been fulfilled. The method also includes receiving, from the fundraising platform, a notification of an impact of their donation including a rank indicative of the fulfillment portion.

In further embodiments, the notification includes a link enabling the impact of their donation to be shared with a social media site.

In various embodiments, there is provided a computer system having at least a processor, a memory and a network interface. The computer system is configured, for example by executing computer program instructions stored in memory, to perform one or more of the above-described methods. In various embodiments, there is provided a computer program product comprising a (e.g. non-transitory) computer readable medium. The computer readable medium has recorded thereon statements and instructions which, when executed by a computer system, cause the computer system to perform one or more of the above-described methods.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 provides a view of a digital platform (e.g. computer system) for implementing the methods described herein, according to an embodiment.

FIG. 2 provides a block diagram of methods used by a non-profit organization to create, define, and edit bundles, according to an embodiment.

FIG. 3 provides a block diagram of methods used by a donor 108 may select bundles donate, according to an embodiment.

FIG. 4 provides a block diagram of methods used when a non-profit organization fulfills a donation, according to an embodiment.

FIG. 5 provides a block diagram of methods used by a digital fundraising platform to account for payments made to a non-profit organization, according to an embodiment.

FIG. 6 provides a block diagram of methods used by a digital fundraising platform to provide feedback and reporting to a donor, according to an embodiment.

FIG. 7 provides a block diagram of methods used by a digital fundraising platform to provide feedback, auditing, or scoring to a non-profit organization, according to an embodiment.

It will be noted that throughout the appended drawings, like features are identified by like reference numerals.

### DETAILED DESCRIPTION

Embodiments of the present invention provide a digital fundraising platform that is based on the impact of a donation rather than a monetary amount of a donation. Embodiments provide donors with an impact driven approach to donating and clarity surrounding how funds will be divided between mission delivery and other operational needs. Embodiments provide non-profits with a way to update their donors on the impact delivered utilizing the donor's donation during program execution and provide a mechanism to communicate proof of impact of dollars spent on both mission and operational activities.

Embodiments provide a digital fundraising platform that allow donors or supporters of a charity or other fundraising organization to donate with clarity on impact. The platform provides a non-profit organization a platform that provides a visual display of the impact of a donation, as well as a monetary amount, that increases the engagement of donors and leads to an improved donor experience and leads to increased donations. In embodiments, impact may refer to specific quantitative outcomes of the activities the donation is used for. The dollar amount paid for the donation funds activities which will lead to tangible outcomes (impact) that the donors have designated their donation towards. The impact must be quantitative in nature as to facilitate donors committing to an amount of impact to fund and a nonprofit fulfilling on a quantity of impact.

Embodiments thus receive information indicative of donations and their use and impact, and provide output indicative of impact of donations. The output may be generated based on the input and has a particular form and/or character which is designed to be evocative or meaningful to donors or potential donors. This transformation of information and provision of tangible, evocative output may encourage further goodwill and/or further donation. For example, the output information indicative of impact of donations may be particularly useful in this regard. Accordingly, embodiments of the present invention generate output based on input, where the output itself includes specific information reported to donors, and the input is specific information about donations as well as an associated charitable activity. Furthermore, the output may create tangible and measurable results such as but not necessarily limited to donor engagement, goodwill, and publicity related results.

Embodiments provide a breakdown of the portion of donations that are used for mission execution, overhead, processing fees, and other expenses, that leads to increased transparency and donor satisfaction.

Embodiments provide a nonprofit organization a platform to capture and share its mission and operational execution to provide supporting donors with visibility into their performance and operations. Nonprofit organizations are provided with mechanisms to push these updates via a myriad of social media platforms. The updates may be pushed via a single interface provided by the platform.

Embodiments provide nonprofit organizations with a way to articulate information and educate supporters on a dollar breakdown for mission vs overhead vs execution costs. Organizations are provided a queue to track and communicate dollars in, vs. the impact delivered by the efforts. The platform provides a full solution for nonprofits to share and communicate compliance and transparency to build trust with supporters. A queue may refer to a data structure with multiple entries, each holding information. The queue may be treated according to a rule such as a first-in-first-out rule, by which entries are added to the queue, and subsequently retrieved from the queue for handling. A queue may be associated with a database, e.g. as a queue of pointers to entries in the database. Entries in the queue can be handled, at least in part, serially.

Embodiments provide users of the platform; nonprofit organizations, donors, or the platform service providers with a platform to provide impact updates and to simultaneously push posts using social media platforms and messaging.

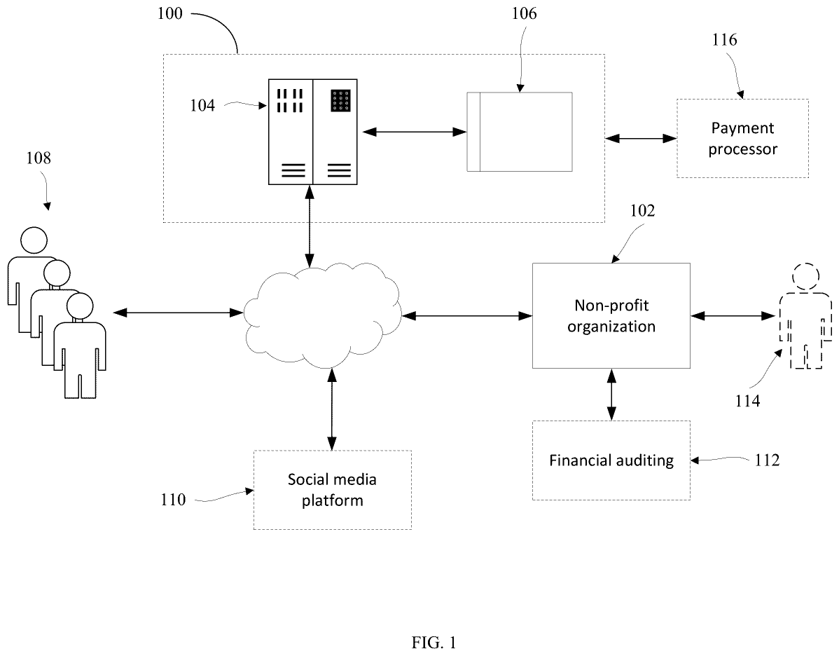

FIG. 1 provides a view of a digital platform 100 for implementing the methods described herein, according to an embodiment. The platform is hosted on a server 104 and associated database 106 which may be located on one or several computer systems connected by communications networks as is known in the art. Servers may include physical or virtual computer systems and be located at a central location or be distributed as is known in the art. Each computer system includes a processor and a mix of non-transitory memory and storage for the storage of computer software including an operating system, programs, and data files. Computer programs include instructions that are read from memory or storage and executed by a processor to implement the methods described herein. Database 106 may be hosted on the server 104 or on a remote server, cloud computing platform, or other local or remote platform as is known in the art. The digital platform, and indeed various embodiments of the invention, can be implemented using a computer system such as a single computer, a plurality of networked computers, or a plurality of computer components for example in one or more locations and configured through virtualization to provide a computer system.

Digital platform 100 is used by a non-profit fundraising organization 102 which may be a charity, non-profit organization, political organization, or any other individual or organization that are involved in fundraising activities. The organization 102 may participate in the platform 100 through one or more computing devices such as a computer, tablet, smartphone, etc. as is known in the art, and communicate with server 104 through any combination of wired or wireless communications networks. The organization 102 includes, has access to, or is accessed for financial auditing 112 purposes to evaluate the financial performance with respect to donations received as part of the digital platform 100.

Donors 108 may include one or more individuals or groups that make donations to the organization 102. Donors 108 may participate in the platform 100 through one or more computing devices such as a computer, tablet, smartphone, etc. as is known in the art, and communicate with server 104 through any combination of wired or wireless communications networks.

Beneficiaries 114 may receive the benefits of the donation and the impact of a donation may be the impact as received or perceived by the beneficiaries 114. In embodiments, the beneficiary 114 may also be the non-profit organization 102, for example, in the case of hospital or shelter performing fundraising for their own benefit.

Social media platform 110 may be used by any of the parties involved, a platform provider of server 104, any organization 102, or donors 108 to publicize their involvement in the digital fundraising platform 100, their donations, the impact of the donations, and the performance of the non-profit organization 102 to their plan. As used herein, social media platform 110 may include any social media platform a such as Facebook, Instagram, Snapchat, Twitter, TikTok, Reddit, as well as messaging solutions such as text messages, iMessages, email, Facebook Messenger, WhatsApp, Discord, etc. to allow any of the parties to communicate with their stakeholders, members, supporters, etc. Integrating the sharing of the impact of donations on social media increases the involvement and satisfaction of donors 108 to the platform 100. Payment processor 116 is used to process the payment from donors 108, the platform 100, or to beneficiaries 114, as required. Payment processor 116 may be a separate entity from the provider of the platform 100 or may be an additional service provided as part of platform 100.

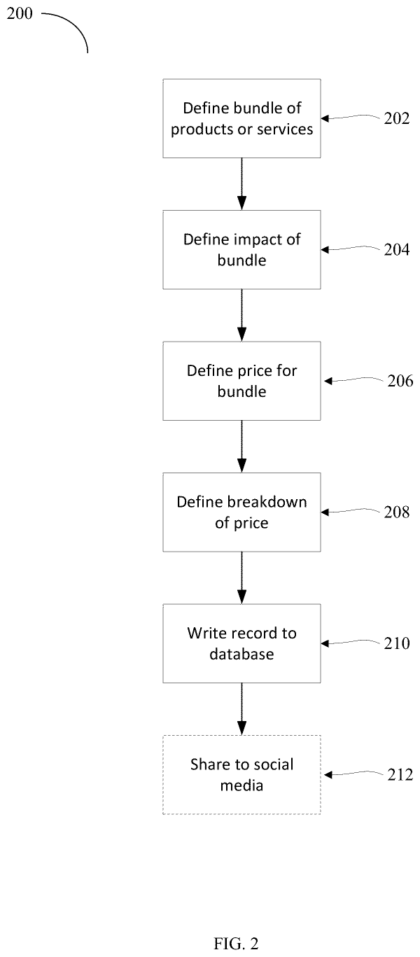

FIG. 2 provides a block diagram of methods 200 used by a non-profit organization 102 to create, define, and edit bundles, according to an embodiment. Organization 102 may be a non-profit organization, a charity, or any other individual or organization that is involved in accepting donations or fundraising. In embodiments, organization 102, instead of accepting undesignated monetary donations, accepts monetary donations designated to specific “impact.” Examples of impact include a benefit provided to the beneficiary of the donation such as providing a Christmas dinner to a quantity of families, sending a quantity of children to camp, planting a quantity of trees, reducing a quantity of carbon emissions, etc. The benefit may be tangible and may be specific as necessary to be evocative when communicated to donors. An impact may include a plurality of products or services such as providing a holiday dinner to a quantity of families together with a gift for all the children in the quantity of families. Another example may be to provide a bicycle to a quantity of children together with lessons to learn how to ride the bicycle. The combination of products or services, or both products and services together with the impact it provides to the beneficiary is referred to herein as a “bundle.” A bundle may also have a single designated beneficiary or a quantity of beneficiaries that a donor 108 may choose. For example, a bundle containing a holiday dinner may be directed towards a homeless shelter, a low-income family, or a newly arrived refugee family. Beneficiaries may be a specific person, family, or organization, or may indicate a class, group, or type of beneficiary to be selected by the non-profit organization 102.

In step 202, the organization 102 defines the number of bundles that they will offer to donors. Bundles are used for donations as well as reporting on the fulfillment of the donations. As well as stating and impact, each bundle may have a name or caption, and have an associated audio/visual file attached to it such as an image, audio clip, or video. The audio/visual file is designed to create a positive emotional response in a potential donor that is considering making a donation that includes the bundle. Bundles may be structured to be fulfilled completely at one time or may include multiple portions that are delivered at regular intervals or based on a schedule or in response to events. In step 204 an impact is associated with each bundle which is a non-monetary benefit that a beneficiary of the donation will receive when the donation is fulfilled by the organization 102. In step 206, a price is assigned to each bundle which is the price that a donor must pay to purchase one or more bundles to produce the impact. The bundle price of step 206 will include the total price that a donor 108 will pay to make a donation of the bundle. For each price assigned in step 206, in step 208 a breakdown of the price will be produced. The price breakdown may include, including a price for the goods or services that a beneficiary will receive. The price delivery costs, taxes, a per bundle overhead for the contents of the bundle, a general overhead cost of the organization 102, etc. In embodiments, the price breakdown may be included on a separate line item for accounting and auditing purposes when the organization 102 makes a transfer of funds received from a donor 108 to the organization 102 as part of a donation. In step 210, the bundle information may be stored in a database 106 in records associated with the organization 102. The organization 102 may also create campaign pages that contain one or more bundles. Campaign pages may be shared with donors or other contacts of the organization 102. For example, a campaign page for Christmas could contain only 2 of 12 bundles of an organization 102 related to Christmas. Optionally, in step 212, the organization 102 is provided with a link to easily share their available bundles on a social media or messaging platform 110.

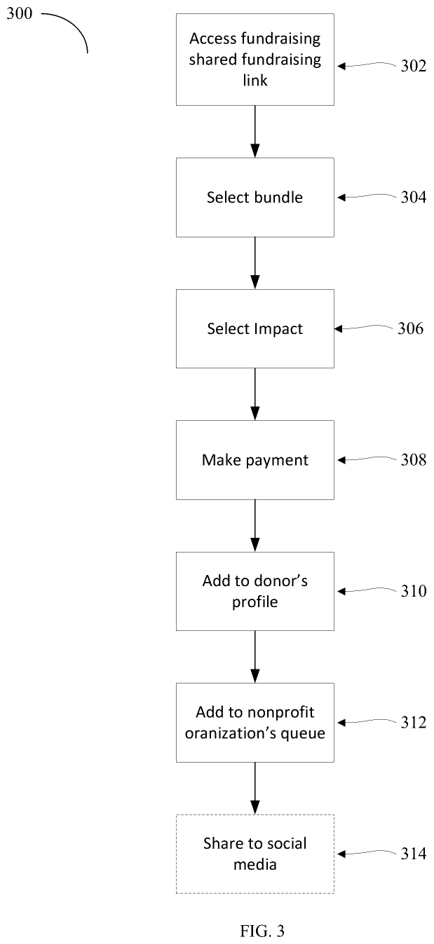

FIG. 3 provides a block diagram of methods 300 used by a donor 108 may select bundles to donate, according to an embodiment. In step 302 a donor may access a server 104 of the platform 100 and access bundles available from any number of organizations 102 for any number of fundraising causes. Donors 108 may be presented with the total impact of an organization 102 or a list of past deliveries of a bundle by the organization. The total impact may include an indication of a partial amount or a total amount of the impact delivered by the organization. The total impact may be based on the past performance of the organization 102 regarding transparency and meeting the bundle breakdown defined in step 208 of method 200. Donors 108 may access the platform 100 through an electronic device such as a smartphone and swipe through impact options in an intuitive way, make donations based on a designated impact, and understand the organization's breakdown on dollars based on mission delivery, overhead and operational costs.

In embodiments, a donor may receive a link that, when accessed, directs them to one or more bundles of a fundraising organization 102. In step 304, if not already selected through a link, the donor selects one or more bundles for a donation. In step 306, the donor may view the impact of any and all selected bundles and the benefit that will be received by beneficiaries 114, which may be the organization 102 itself. When selecting an impact, a donor may be presented with multi-media elements that may produce an emotional effect that encourage them to make donations. For example, multimedia elements may include a live ticker or animated bubbles with realtime information on who else gave or is giving to the same non-profit organization 102 or the same bundle. In step 308 the donor makes a payment associated with the selected bundle and the quantity selected. In embodiments, the payment may involve a variable price as well as financing options. In step 310, the selected bundles, their quantity, and associated metadata is stored to a profile of the donor 108 allowing the organization 102 and the donor 108 to track their donation, impact, and payment history, where permitted by privacy legislation, rules, and settings. In step 312, the platform 100 adds the donation to a queue. Optionally, in step 314, the donor 108 is provided with a link to easily share their information regarding their donations and their designated impact on a social media or messaging platform 110. The donor 108 may also use the link to create a campaign page offer a challenge to contacts, friends, family, and others to match or make a similar donation, including the impact of that donation. In embodiments, donations made by the original donor 108 as well as donations made in response to the original donor's 108 social media post may be grouped into a fundraising group.

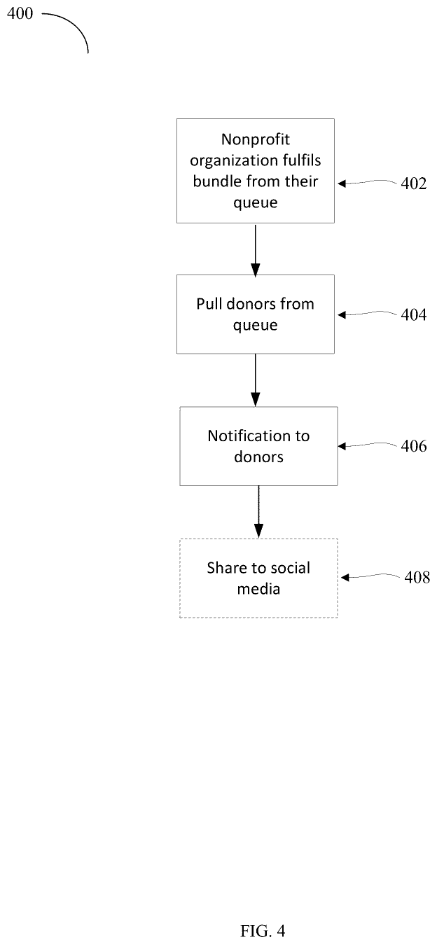

FIG. 4 provides a block diagram of methods 400 used when a non-profit organization fulfills a donation, according to an embodiment. In step 402, donations that are queued in step 312 of method 300 are made available to the fundraising organization 102. Depending on the resources available to the organization 102, a number of donations may be received from the queue for fulfillment. The organization 102 then fulfills the donations that it received, makes purchase of goods or services required to fulfill each donation and provides the donated goods or services to the beneficiaries 114. In step 404, the organization also receives the donors 108 of the fulfilled donations. In embodiments, step 402 and step 404 may occur simultaneously. In embodiments, steps 402 and 404 may occur sequentially. In step 406, the platform 100 send notifications to the donors 108 that have had donations fulfilled or partially fulfilled. For example, a donor 108 may have specified a bundle that is delivered in separate portions over a period of time or several bundles that are not fulfilled simultaneously. As donations are fulfilled, the platform 100 may use notifications to inform the donors 108 how many of their donations have been fulfilled and how many remain to be fulfilled. When a predetermined small number of donations are left or if all donations have been fulfilled, the donor 108 may be prompted to make additional donations, or repeated donations, such as monthly or annual donations. In step 408, the notification may include a link to easily share their information regarding their donations and their impact on a social media or messaging platform 110.

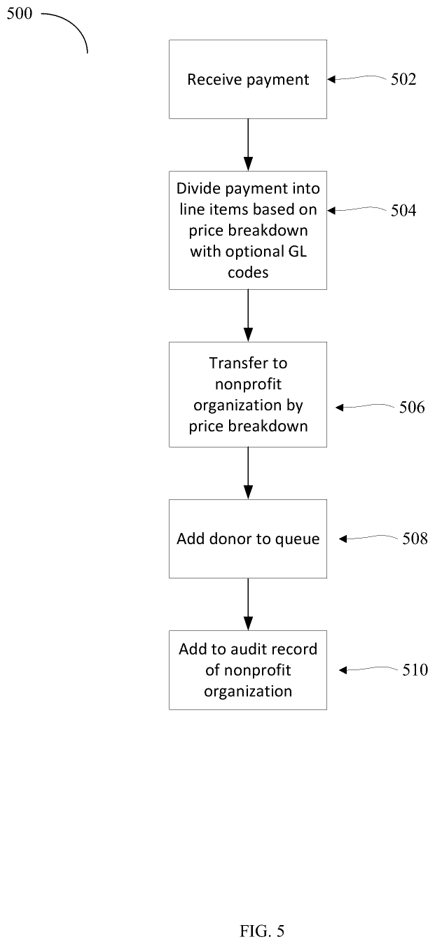

FIG. 5 provides a block diagram of methods 500 used by a digital fundraising platform to account for payments made to a non-profit organization, according to an embodiment. In step 502 the non-profit organization 102 receives funds from the platform 100 or the payment processor 114 in response to the platform 100 receiving donations from donor 108. The payment or transfer information includes a price breakdown as defined in step 208 of method 100. In step 504 invoicing, documentation, or other financial reporting may also be generated with separate line items based on the price breakdown. Optionally, GL codes, accounts, or financial categories may be included with each line item of the price breakdown. In step 506, the organization 102 receives the funds transfer including the price breakdown information which may be used to divide the funds received as listed in the price breakdown for financial or accounting purposes. In step 508, the donor 108 that made the payment may be added to the queue or the donor's record that may already be in the queue may be updated to indicate that payment has been made and fulfillment may occur. In step 510, the payment and price breakdown may be added to an audit record of the non-profit organization 102 for later comparison of spending of the organization to the received price breakdown. Optionally, the performance of the organization 102 with respect to meeting their price breakdown targets may be used to generate or update a metric which is an indication of their transparency and performance as a fundraising organization. The rank may be made available to potential donors and may also be used by the organization 102 for self promotion.

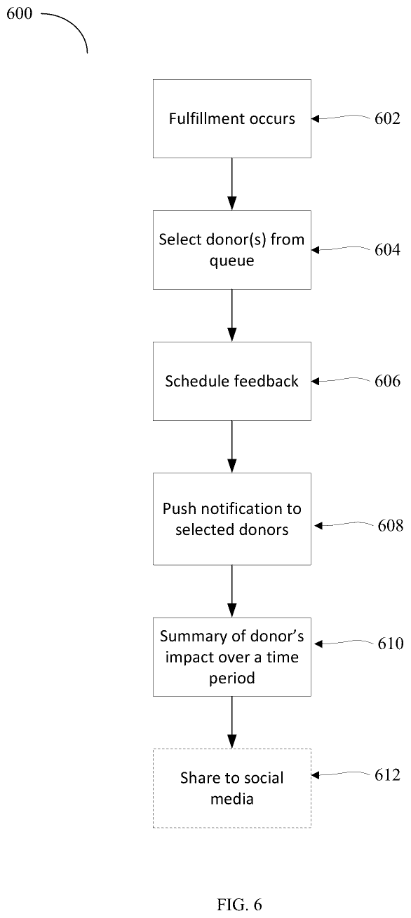

FIG. 6 provides a block diagram of methods 600 used by a digital fundraising platform to provide feedback and reporting to a donor, according to an embodiment. In step 602 fulfillment occurs with the organization 102 providing goods and services to beneficiaries 114 as step 402 of method 400. In step 604, a donor 108, including their donation or partial donation is selected from the queue which may occur immediately after fulfillment of a donation or after a delay. Feedback from the platform 100 to the donor is scheduled in step 606. In step 608 notifications that fulfillment has occurred may be sent or pushed to the selected donor 108 and sent. Donors 108 may specify preferences on how they wish to be notified. In step 610, the notification may include not just notice of a donation being fulfilled but the impact of the donation, the impact of selected past donations, or a summary of the impact of past donations. The notification may include reminders or prompts for the donor 108 to make additional donation either on an ad-hoc basis or based on a schedule. Notifications may include audio-visual elements such as sound and video to get the donor's attention and give them an increased sense of belonging and accomplishment from the impact of their donation. Optionally, in step 612 the donor 108 is provided with a link to easily share the impact of their donations on a social media or messaging platform 110. Notifications to the donor may include audio-visual material that may easily be shared on social media. As an example, a notification may be provided in real-time or soon after an accomplishment or impact related to a donation is realized.

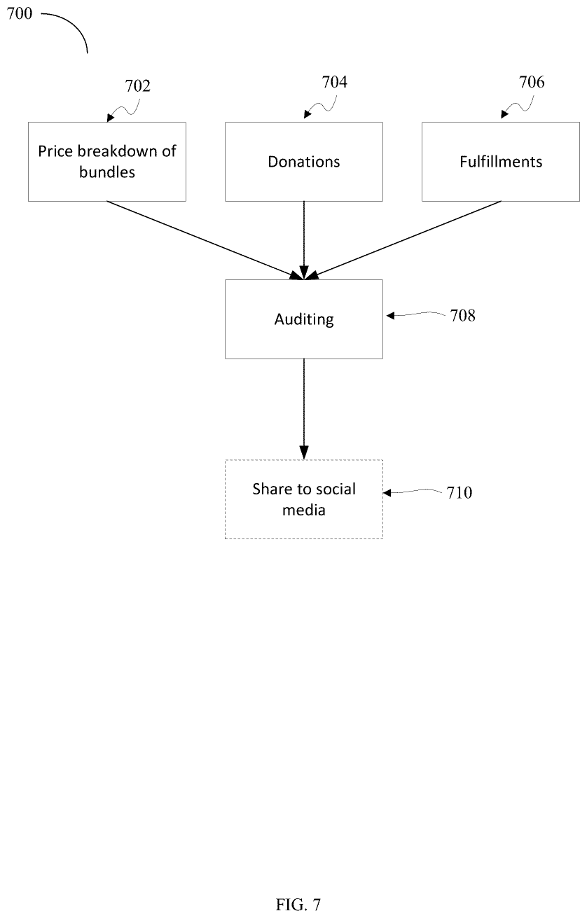

FIG. 7 provides a block diagram of methods 700 used by a digital fundraising platform to provide feedback, auditing, or scoring to a non-profit organization, according to an embodiment. Auditing may be used to determine a rank of the fundraising organization 102 that is an indication of the organization's 102 transparency and performance related to the price breakdown for the bundles of the organization 102. Auditing 708 may be conducted by an internal or external organization and look at the price breakdown of bundles 702, the quantity and type of donations 704, and the accuracy, speed, or quality of the fulfillment process 706. Auditing 708 can be used to produce one or more ranks for the organization that is available to donors 108. Ranks may also be used by the platform 100 provider to identify high and low performers. Optionally, in step 710 the ranks may be shared on a social media or messaging platform 110.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

What is claimed is:

1. A method for raising funds comprising, by a computer system:
receiving, from an organization, a bundle including an impact;
receiving, from a plurality of donors, a plurality of donations, each of the plurality of donations including a quantity of the bundle, the plurality of donations being stored in a queue;
receiving, from the organization, a notification that a portion of the plurality of donations in the queue have been fulfilled, and determining the donors whose donations are deemed to have been fulfilled; and
sending, to the donors, a notification of an impact of their donation and marking the donations as fulfilled.

2. The method of claim 1, wherein the bundle further includes a price and a breakdown of the price indicating a fulfillment portion of the price.

3. The method of claim 2, wherein the notification of an impact of their donation includes a fulfillment portion of the impact of their donation and animations to generate an emotional response from the donor.

4. The method of claim 1, wherein the notification of an impact of their donation includes a link enabling the impact of their donation to be shared with a social media site.

5. The method of claim 1, wherein the notification of an impact of their donation is spaced out in time to increase an emotional impact to the donor.

6. The method of claim 1 further comprising:
sending, to the organization a notification of performance including an impact of the plurality of donations of the bundle;
wherein the notification of performance includes a link enabling the impact of the plurality of donations of the bundle to be shared with a social media site.

7. The method of claim 6 wherein the plurality of donors are presented with the notification of performance is made available to the plurality of donors.

8. The method of claim 1, wherein the donations that are deemed to have been fulfilled are subsequently removed from the queue.

9. A method for making donations comprising:
receiving, from a fundraising platform, a plurality of bundles, each of the plurality of bundles associated with an organization and including an impact;
sending, to the fundraising platform, a donation including a selected bundle of the plurality of bundles and a quantity of the selected bundle; and
receiving, from the fundraising platform, a notification that a portion of the donation has been fulfilled, the notification including an indication of an impact of the portion of the donation and an animation to increase an emotional impact of the donation.

10. The method of claim 9 wherein each of the plurality of bundles further includes an indicator of effectiveness of the organization including a fulfillment portion of the impact of the bundle.

11. The method of claim 9, wherein the notification that the portion of the donation has been fulfilled further includes a link enabling the impact of their donation to be shared with a social media site.

12. A method for raising funds comprising:
sending, to a fundraising platform, a bundle including an impact, the impact defining a fulfillment portion;
receiving, from the fundraising platform, a plurality of donations of a plurality of donors, each of the plurality of donations including a quantity of the bundle;
receiving, from the fundraising platform, a payment for the plurality of donations including a portion indicating the fulfillment portion;
sending, to the fundraising platform, a report indicating that a portion of the plurality of donations have been fulfilled;
receiving, from the fundraising platform, a notification of an impact of their donation including a rank indicative of the fulfillment portion.

13. The method of claim 12, wherein the notification includes a link enabling the impact of their donation to be shared with a social media site.
